(19) United States
(12) Patent Application Publication
(10) Pub. No.: US 2017/0222782 A1
(43) Pub. Date: Aug. 3, 2017

(54) METHOD AND DEVICE FOR SECONDARY BASE STATION CHANGE IN DUAL CONNECTIVITY SYSTEM

(71) Applicant: ALCATEL LUCENT, Boulogne-Billancourt (FR)

(72) Inventors: Pingping Wen, Shanghai (CN); Chandrika Worrall, Newbury (GB)

(73) Assignee: Alcatel Lucent, Boulogne Billancourt (FR)

(21) Appl. No.: 15/500,718

(22) PCT Filed: Jul. 30, 2015
(86) PCT No.: PCT/IB2015/001485

§ 371 Date: Jan. 31, 2017

(30) Foreign Application Priority Data
Aug. 7, 2014 (CN) 201410387771.0

(51) Int. Cl. H04L 5/00; H04W 72/02

(52) U.S. Cl. CPC H04L 5/0055; H04W 72/02; H04W 88/06

(57) ABSTRACT

Embodiments of the present invention provide methods and devices for secondary base station change in a dual connectivity system. The method comprises: determining, at a secondary base station, to initiate secondary base station change procédure; sending, at the secondary base station, a secondary base station change request to a master base station based on the détermination; and receiving a secondary base station change request acknowledgement from the master base station, wherein the secondary base station change procedure is initiated by the secondary base station.

### FIELD OF THE INVENTION

The present invention relates to the communication field, and more particularly, to a method and device for secondary base station change in a dual connectivity system.

### BACKGROUND OF THE INVENTION

Currently, dual connectivity has being standardized in the 3rd Generation Partnership Project (3GPP). Dual connectivity involves the UE connecting to a master base station (e.g., master eNB, referred to as MeNB for short) and several secondary base stations (e.g., secondary eNB, referred to as SeNB for short) at the same time.

In existing solutions, it has been designed procedures to support SeNB change initiated by the MeNB. MeNB initiated SeNB change procedure follows SeNB addition and release, and during SeNB addition, new radio configuration is performed for the user equipment (UE) by the SeNB.

When system information on a special SeNB cell changes, SeNB initiated SeNB change procedure might be required. For example, if SeNB change procedure is to be used for the system information change on the SeNB cell, SeNB initiated SeNB change procedure is required. However, SeNB initiated SeNB change procedure is not supported in the dual connectivity system currently.

In addition, there has been proposed to use one radio resource control (RRC) message to release and add the SeNB cell for updating system information of the

SeNB cell. That is, the solution for system information update of SeNB cells of SCG requires to release and add SeNB cells in the same RRC message. Even though SeNB release can be triggered by the SeNB, SeNB addition cannot be triggered by the SeNB in conventional solutions. In this regard, there are still open issues to be solved. For example, what kind of procedure is used to generate the RRC message, whether the current solution can perform the complete system information update and whether new procedure should be defined, and so on.

Therefore, there is a need for a solution regarding SeNB initiated SeNB change procedure and SeNB initiated SeNB addition procedure in the dual connectivity system.

### SUMMARY OF THE INVENTION

In view of the above problems, the present invention provides a solution to the SeNB initiated SeNB change procedure and the SeNB initiated SeNB addition procedure in a dual connectivity system. The technical solution of the present invention can be used to achieve system information update of SeNB secondary cells and special SeNB cells in a secondary cell group (SCG).

According to a first aspect of the present invention, there is provided a method for performing SeNB change in a dual connectivity system. The method may be performed by a SeNB, and comprise: determining, at a SeNB, to initiate SeNB change procedure; sending, at the SeNB, a SeNB change request to a MeNB based on the determination; and receiving a SeNB change request acknowledgement from the MeNB.

According to a second aspect of the present invention, there is provided a method for performing SeNB change in a dual connectivity system. The method may be performed by a MeNB, and comprise: receiving, at a MeNB, a SeNB change request from a SeNB; and sending a SeNB change request acknowledgement from the MeNB to the SeNB, wherein SeNB change procedure is initiated by the SeNB.

According to a third aspect of the present invention, there is provided a SeNB modification method in a dual connectivity system. The method may be performed by a SeNB, and comprise: determining, at a SeNB, to initiate SeNB cell addition procedure; sending, at the SeNB, a SeNB cell addition request to a MeNB based on the determination; and receiving a SeNB cell addition request acknowledgement from the MeNB.

According to a fourth aspect of the present invention, there is provided a SeNB modification method in a dual connectivity system. The method may be performed by a MeNB, and comprise: receiving, at a MeNB, a SeNB cell addition request from a SeNB; and sending a SeNB cell addition request acknowledgement to the SeNB from the MeNB, wherein SeNB cell addition procedure is initiated by the SeNB.

According to a fifth aspect of the present invention, there is provided a device for performing SeNB change in a dual connectivity system. The device may be included in a SeNB. The device may comprise: a determining unit configured to determine, at a SeNB, to initiate SeNB change procedure; a sending unit configured to send a SeNB change request to a MeNB based on the determination made by the determining unit; and a receiving unit configured to receive a SeNB change request acknowledgement from the MeNB.

According to a sixth aspect of the present invention, there is provided a device for performing SeNB change in a dual connectivity system. The device may be included in a MeNB. The device may comprise: a receiving unit configured to receive a SeNB change request from a SeNB; and a sending unit configured to send a SeNB change request acknowledgement to the SeNB, wherein SeNB change procedure is initiated by the SeNB.

According to a seventh aspect of the present invention, there is provided a SeNB modification device in a dual connectivity system. The device may be included in a SeNB. The device may comprise: a determining unit configured to determine to initiate SeNB cell addition procedure; a sending unit configured to send a SeNB cell addition request to a MeNB based on the determination made by the determining unit; and a receiving unit configured to receive a SeNB cell addition request acknowledgement from the MeNB.

According to an eighth aspect of the present invention, there is provided a SeNB modification device in a dual connectivity system. The device may be included in a MeNB. The device may comprise: a receiving unit configured to receive a SeNB cell addition request from a SeNB; and a sending unit configured to send a SeNB cell addition request acknowledgement to the SeNB, wherein SeNB cell addition procedure is initiated by the SeNB.

Other features and advantages of the present invention will become apparent from the following description of preferred embodiments illustrating the principles of the present invention, when taken in conjunction with the accompanying drawings.

### BRIEF DESCRIPTION OF THE DRAWINGS

As the present invention is apprehended more thoroughly, other objects and effects of the present invention will become more apparent and easier to understand from the following description with reference to the accompanying drawings, wherein:

FIG. 1 is a flowchart of a method 100 for performing, at SeNB side, SeNB change in a dual connectivity system according to one embodiment of the present invention;

FIG. 2 is a flowchart of a method 200 for performing, at MeNB side, SeNB change in a dual connectivity system according to one embodiment of the present invention;

FIG. 3 is a flowchart of a SeNB modification method 300 in a dual connectivity system at SeNB side according to one embodiment of the present invention;

FIG. 4 is a flowchart of a SeNB modification method 400 in a dual connectivity system at MeNB side according to one embodiment of the present invention;

FIG. 5 is a block diagram of a device 500 for performing, at SeNB side, SeNB change in a dual connectivity system according to one embodiment of the present invention;

FIG. 6 is a block diagram of a device 600 for performing, at MeNB side, SeNB change in a dual connectivity system according to one embodiment of the present invention;

FIG. 7 is a block diagram of a SeNB modification device 700 in a dual connectivity system at SeNB side according to one embodiment of the present invention;

FIG. 8 is a block diagram of a SeNB modification device 800 in a dual connectivity system at MeNB side according to one embodiment of the present invention;

FIG. 9 is a schematic view of MeNB initiated SeNB change procedure 900 according to the prior art;

FIG. 10 is a schematic view of SeNB initiated intra-SeNB change procedure 1000 according to one embodiment of the present invention;

FIG. 11 is a schematic view of SeNB initiated SeNB modification procedure 1100 according to the prior art;

FIG. 12 is a schematic view of SeNB initiated SeNB modification procedure 1200 according to one embodiment of the present invention; and

FIG. 13 is a schematic view of MeNB initiated SeNB modification procedure 1300 according to one embodiment of the present invention.

### DETAILED DESCRIPTION OF EMBODIMENTS

Principles of the subject matter described here are now described with reference to several embodiments. It should be understood that the embodiments are described only for causing those skilled in the art to better understand and further implement the subject matter, rather than limiting the scope of the subject matter in any way.

The term “base station” (BS) used here may represent the node B (NodeB or NB), evolutionary node B (eNodeB or eNB), a remote radio unit (RRU), a radio head (RH), a remote radio head (RRH), a repeater, a low power node such as a Picocell, a Femto cell and the like.

The term “user equipment” (UE) used here refers to any device that can communicate with the BS. As an example, the UE may comprise a terminal, a mobile terminal (MT), a subscriber station (SS), a portable subscriber station (PSS), a mobile station (MS) or an access terminal (AT).

The term “comprise” and its variations used here refer to “include but not limited to”. The term “based on” is “at least partially based on”. The term “one embodiment” represents “at least one embodiment”; the term “another embodiment” represents “at least one another embodiment”. Relevant definition of other terms will be presented in the following description.

Note although the embodiments mainly use a Long Term Evolution (LTE) system as an example for description, this is merely exemplary, and the technical solution of the present invention is completely applicable to other appropriate systems.

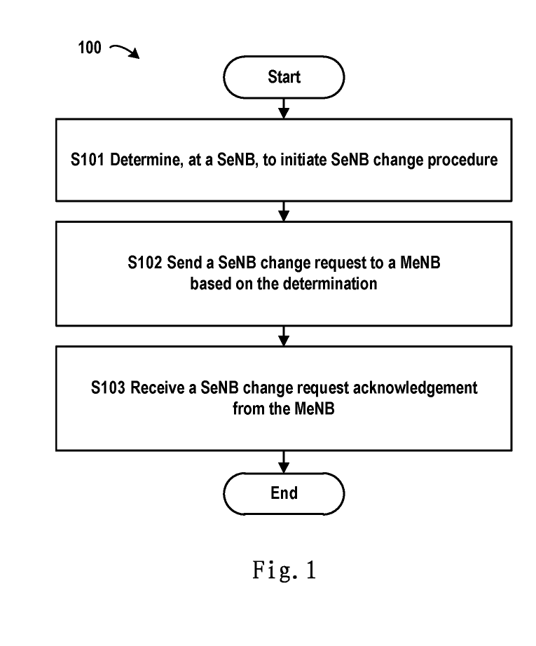

Before an introduction is given to FIG. 1, in order to better understand the present invention, first reference may be made to a schematic view of master base station initiated secondary base station change procedure 900 according to the present art as shown in FIG. 9. The SeNB change procedure according to the prior art as shown in FIG. 9 is initiated by a master base station (e.g., MeNB) and applicable to both inter-SeNB SeNB change procedure and intra-SeNB SeNB change procedure.

Since MeNB initiated SeNB change procedure in the prior art as shown in FIG. 9 does not meet needs of some current scenarios and situations, the present invention proposes SeNB initiated SeNB change procedure. For example, FIG. 1 shows a flowchart of a method 100 for performing, at SeNB side, SeNB change in a dual connectivity system according to one embodiment of the present invention. The embodiment shown in FIG. 1 may be performed by the SeNB or any other appropriate apparatus that is available to those skilled in the art.

In FIG. 1, a SeNB determines to initiate SeNB change procedure in step S101. In step S102, the SeNB sends a SeNB change request to a MeNB based on the determination made in step S101. In step S103, the SeNB receives a SeNB change request acknowledgement from the MeNB.

It is to be noted that in method 100 for performing SeNB change in a dual connectivity system as shown in FIG. 1, the SeNB change procedure is initiated by the SeNB. According to the embodiments of the present invention, system information update of SeNB cells may be performed through the SeNB change procedure.

SeNB cells may comprise special SeNB cells and SeNB secondary cells. According to the embodiments of the present invention, system information update of SeNB cells comprises system information update of special SeNB cells and system information update of SeNB secondary cells.

The SeNB change procedure may comprise inter-SeNB change procedure and intra-SeNB change procedure. When the SeNB change procedure is intra-SeNB change procedure, the procedure does not comprise path switch, data forwarding and other processing.

According to the embodiments of the present invention, in the intra-SeNB change procedure, the SeNB may send to the MeNB an indication for indicating that the SeNB has performed the intra-SeNB change procedure.

According to the embodiments of the present invention, in the intra-SeNB change procedure, the SeNB may send to the MeNB a radio resource control container (RRC container) associated with configuration information of the SeNB which has been changed. In one additional embodiment, the MeNB may determine whether there is system information update, by checking content of the RRC container received from the SeNB.

In the SeNB change procedure according to the embodiments of the present invention, only modified radio parameters are reconfigured. Radio parameters may comprise, for example, quality of service (QoS), correlation information, channel configuration information, system information, and so on. While reconfiguring radio parameters, unmodified parameters may not be re-sent. According to the embodiments of the present invention, modified radio parameters may be sent using delta signaling.

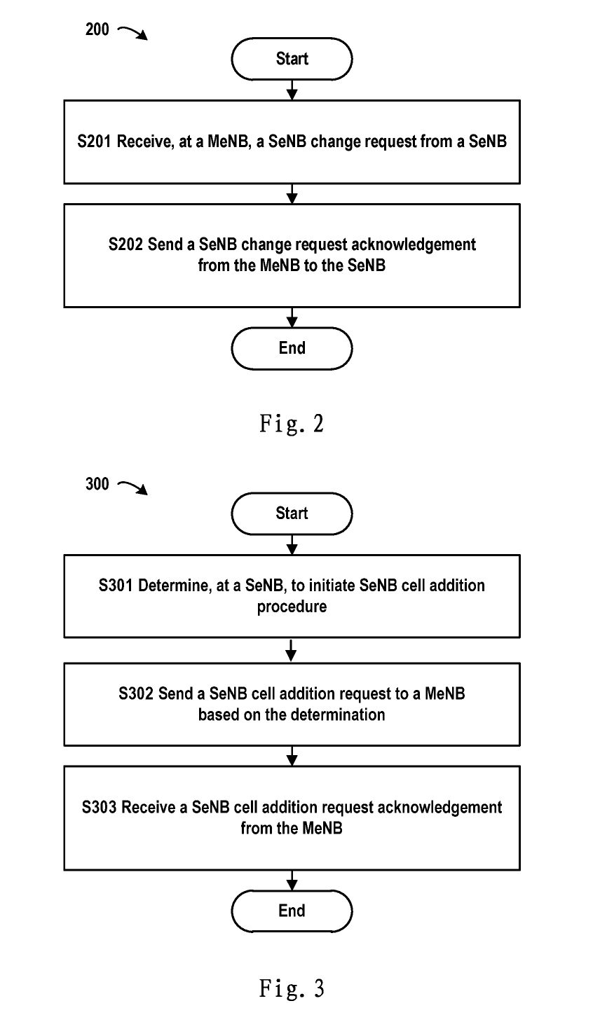

FIG. 2 is a flowchart of a method 200 for performing, at MeNB side, SeNB change in a dual connectivity system according to one embodiment of the present invention. The embodiment shown in FIG. 2 may be performed by the MeNB or any other appropriate apparatus that is available to those skilled in the art.

In the method shown in FIG. 2, a MeNB receives a SeNB change request from a SeNB in step S201. In step S202, a SeNB change request acknowledgement is sent from the MeNB to the SeNB.

Note in method 200 for performing SeNB change in a dual connectivity system as shown in FIG. 2, the SeNB change procedure is initiated by the SeNB. According to the embodiments of the present invention, system information update of SeNB cells may be performed through the SeNB change procedure. According to the embodiments of the present invention, system information update of SeNB cells comprises system information update of special SeNB cells and system information update of SeNB secondary cells.

As described above, the SeNB change procedure may be intra-SeNB change procedure, at which point the procedure does not comprise path switch, data forwarding and other processing.

Method 200 shown in FIG. 2 may additionally or optionally comprise an indication receiving step. According to the embodiments of the present invention, the MeNB may receive from the SeNB an indication that indicates the SeNB has performed the intra-SeNB change procedure.

Method 200 shown in FIG. 2 may additionally or optionally comprise a system information update determining step. According to the embodiments of the present invention, the MeNB may receive from the SeNB a RRC container associated with configuration information of the SeNB which has been changed, and then the MeNB may check content of the RRC container, thereby determining whether there is system information update.

Just as discussed above, only modified radio parameters are reconfigured in the SeNB change procedure. In some embodiments, method 200 shown in FIG. 2 may additionally or optionally comprise a step as below: the MeNB only sends configuration information of modified radio parameters to user equipment.

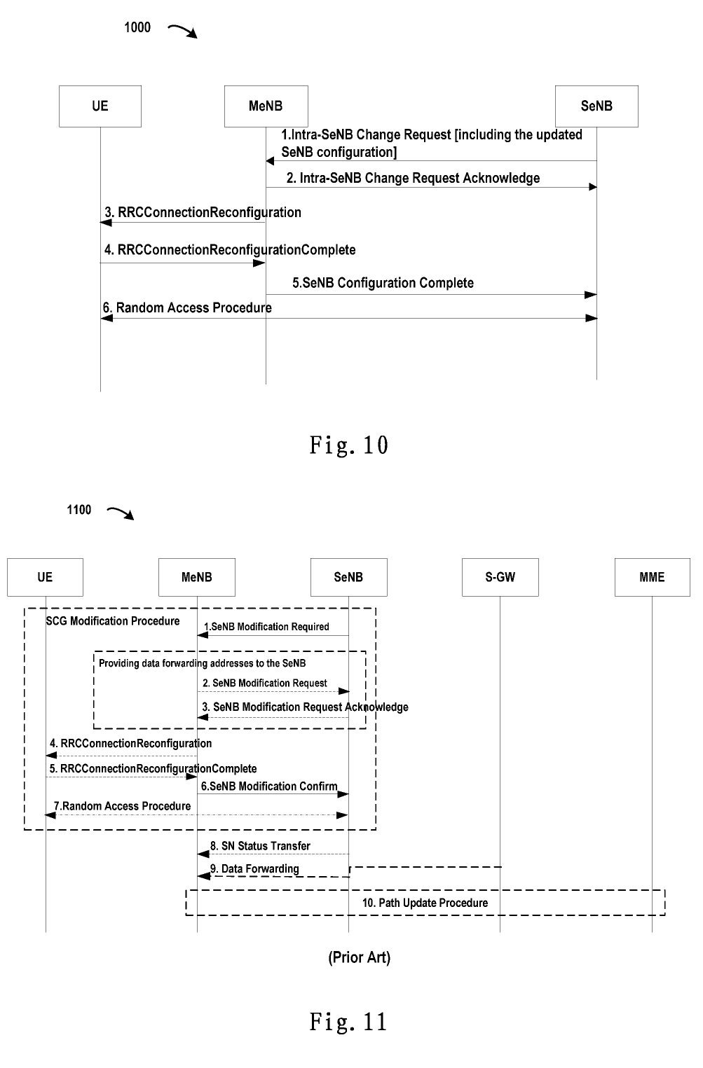

In the embodiments according to the present invention, the SeNB and the MeNB may implement the SeNB initiated SeNB change procedure according to the present invention by using the methods shown in FIGS. 1 and 2 respectively. For example, FIG. 10 shows a schematic view of SeNB initiated intra-SeNB change procedure 1000 according to one embodiment of the present invention. As shown in FIG. 10, the SeNB change procedure is initiated by the SeNB. In step 1, the SeNB sends an intra-SeNB change request to a MeNB, which intra-SeNB change request may comprise updated SeNB configuration. In response to the request, the MeNB sends an intra-SeNB change request acknowledgement to the SeNB in step 2, and continues to implement the SeNB initiated intra-SeNB change procedure in steps 3-6.

As described above, the current scheme for system information update of SeNB cells of SCG requires to release and add SeNB cells in the same RRC message for achieving system information update. Even though SeNB release can be triggered by the SeNB, SeNB addition cannot be triggered by the SeNB in the prior art. FIG. 11 shows a schematic view of SeNB initiated SeNB modification procedure 1100 according to the prior art. As shown in FIG. 11, the SeNB modification procedure in the prior art supports SeNB release but does not support SeNB addition.

To solve this problem, FIG. 3 shows a flowchart of a SeNB modification method 300 in a dual connectivity system at SeNB side according to one embodiment of the present invention. The embodiment shown in FIG. 3 may be executed by a SeNB or any other appropriate apparatus that is available to those skilled in the art.

In the method shown in FIG. 3, a SeNB determines to initiate SeNB cell addition procedure in step S301. In step S302, the SeNB sends a SeNB cell addition request to a MeNB based on the determination made in step S301. In step S303, a SeNB cell additional request acknowledgement is received from the MeNB.

Note in SeNB modification method 300 in the dual connectivity system shown in FIG. 3, the SeNB cell addition procedure is initiated by the SeNB.

According to the embodiments of the present invention, the SeNB may initiate SeNB cell release procedure and SeNB cell addition procedure at the same time. The SeNB may send SeNB cell addition information and SeNB cell release information to the MeNB at the same time, so as to complete system information update of the SeNB cell. In one embodiment according to the present invention, the SeNB cell addition information may comprise updated system information of the added SeNB cell.

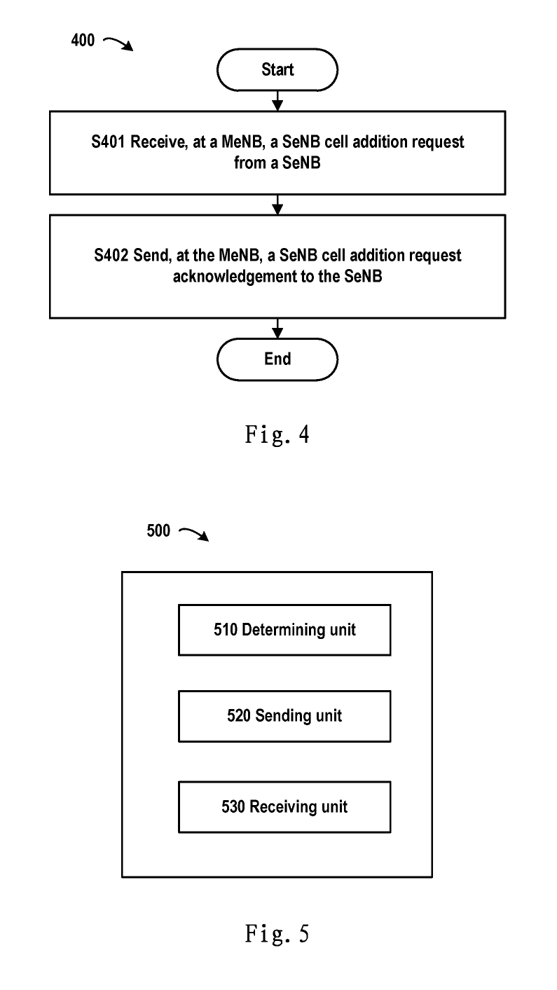

FIG. 4 is a flowchart of a SeNB modification method 400 in a dual connectivity system at MeNB side according to one embodiment of the present invention. The embodiment shown in FIG. 4 may be executed by a MeNB or any other appropriate apparatus that is available to those skilled in the art.

In the method shown in FIG. 4, a SeNB cell addition request from a SeNB is received from a MeNB in step S401. In step S402, a SeNB cell addition request acknowledgement is sent from the MeNB to the SeNB.

It is to be noted that, in SeNB modification method 400 in the dual connectivity system shown in FIG. 4, the SeNB cell addition procedure is initiated by the SeNB.

According to the embodiments of the present invention, the SeNB may initiate SeNB cell release procedure and SeNB cell addition procedure at the same time. The SeNB may send SeNB cell addition information and SeNB cell release information to the MeNB at the same time, so as to complete system information update of the SeNB cell. In one embodiment according to the present invention, the SeNB cell addition information may comprise updated system information of the added SeNB cell.

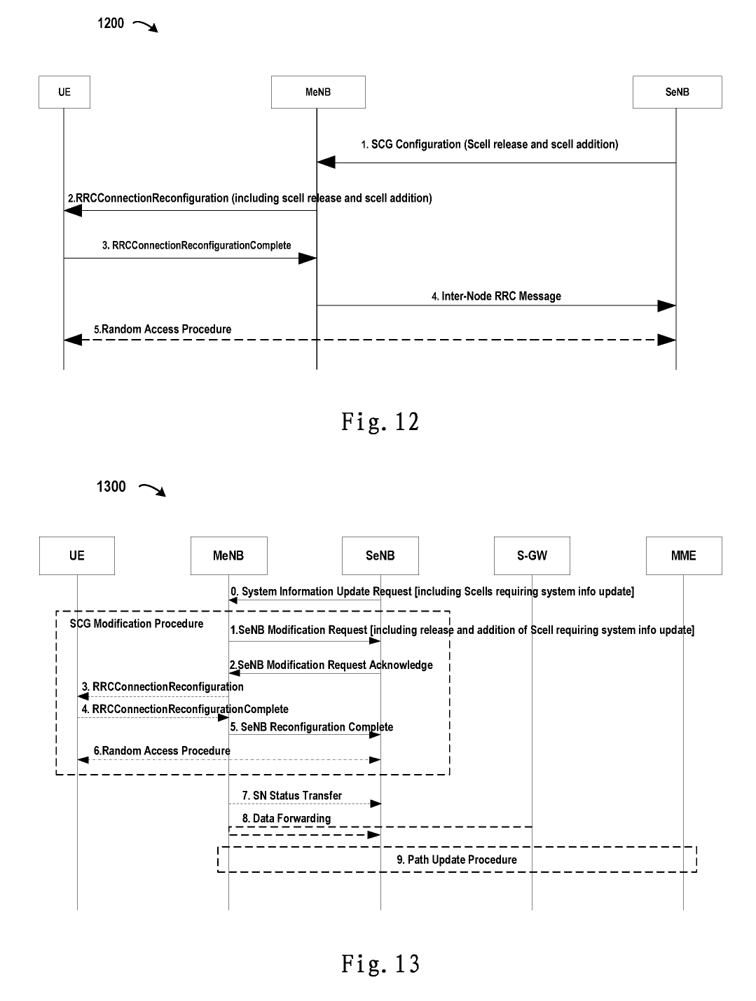

Using the methods of the embodiments shown in FIGS. 3 and 4, both the SeNB and the MeNB can achieve the SeNB initiated SeNB cell addition procedure. In this regard, FIG. 12 shows a schematic view of an embodiment of such procedure 1200. In the procedure shown in FIG. 12, the SeNB concurrently initiates SeNB cell release procedure and SeNB cell addition procedure. The SeNB concurrently sends SeNB cell addition information and SeNB cell release information to the MeNB so as to complete system information update of SeNB cells.

As shown in FIG. 12, the SeNB can trigger both the SCG SeNB cell release and SeNB cell addition simultaneously in step 1. Then, the MeNB generates one RRC message (e.g., RRC Connection Reconfiguration message) to the UE in step 2. Later, the SeNB modification procedure is continued in steps 3-5. Using the procedure in FIG. 12, the system information update of SeNB cells can be performed.

FIG. 13 is a schematic view of MeNB initiated SeNB modification procedure 1300 according to one embodiment of the present invention. In the embodiment shown in FIG. 13, the SeNB modification procedure is initaited by a MeNB. In this embodiment, a SeNB does not support SeNB cell addition, so the SeNB may indicate to the MeNB in one message that there is system information change for a specific SeNB cell. Then, in response to the message from the SeNB, the MeNB performs both MeNB initiated SeNB cell addition and release.

As shown in FIG. 13, the SeNB may send a system information update request message to the MeNB, which message may comprise SeNB cell ID that requires system update. Thus, the MeNB performs the MeNB initiated SeNB modification procedure and requests the SeNB to release and add SeNB cells that require system update. In response to the request of the MeNB, the SeNB responds to MeNB initiated SeNB modification and simultaneously sends new system information, which is then sent by the MeNB to the user equipment by RRC signaling.

FIG. 5 is a block diagram of a device for performing, at SeNB side, SeNB change in a dual connectivity system according to one embodiment of the present invention. The device shown in FIG. 5 may be contained in a SeNB or any other appropriate apparatus that is available to those skilled in the art.

As shown in FIG. 5, device 500 may comprise: a determining unit 510 configured to determine, at a SeNB, to initiate SeNB change procedure; a sending unit 520 configured to send a SeNB change request to a MeNB based on the determination made by determining unit 510; and a receiving unit 530 configured to receive a SeNB change request acknowledgement from the MeNB.

According to the embodiment of the present invention, system information update of a SeNB cell may be performed through the SeNB change procedure.

According to the embodiment of the present invention, the system information update of a SeNB cell may comprise system information update of a special SeNB cell and system information update of a SeNB secondary cell.

According to the embodiment of the present invention, the SeNB change procedure may be intra-SeNB change procedure, which does not comprise path switch or data forwarding.

According to the embodiment of the present invention, sending unit 520 may further be configured to: send to the MeNB an indication that indicates the SeNB has performed the intra-SeNB change procedure.

According to the embodiment of the present invention, sending unit 520 is further configured to: send to the MeNB a radio resource control container associated with configuration information of the SeNB which has been changed.

According to the embodiment of the present invention, the MeNB may determine whether there is system information update, by checking content of a radio resource control container received from the SeNB.

According to the embodiment of the present invention, only modified radio parameters are reconfigured in the SeNB change procedure.

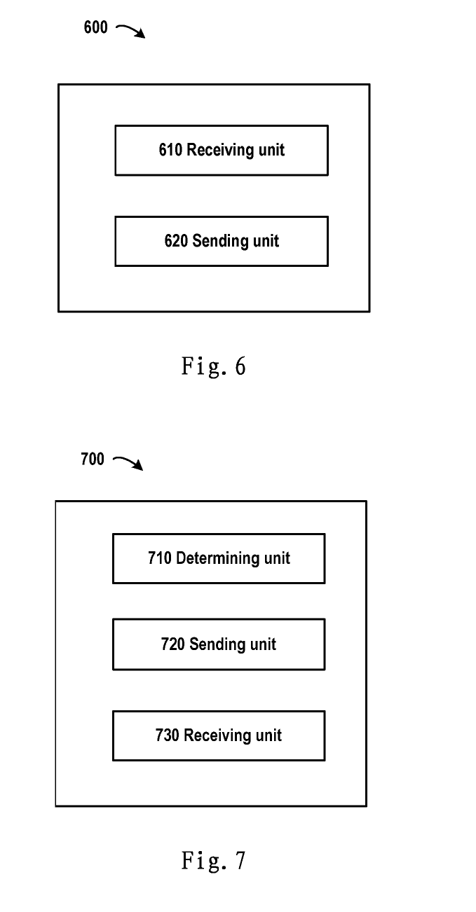

FIG. 6 is a block diagram of a device 600 for performing, at MeNB side, SeNB change in a dual connectivity system according to one embodiment of the present invention. The device shown in FIG. 6 may be contained in a MeNB or any other appropriate apparatus that is available to those skilled in the art.

As shown in FIG. 6, the device 600 may comprise: a receiving unit 610 configured to receive a SeNB change request from a SeNB; and a sending unit 620 configured to send a SeNB change request acknowledgement to the SeNB, wherein the SeNB change procedure is initiated by the SeNB.

According to the embodiment of the present invention, system information update of SeNB cells is performed by the SeNB change procedure.

According to the embodiment of the present invention, the SeNB change procedure is intra-SeNB change procedure, which does not comprise path switch or data forwarding.

According to the embodiment of the present invention, the receiving unit 610 may further be configured to: receive from the SeNB an indication that indicates the SeNB has performed the intra-SeNB change procedure.

According to the embodiment of the present invention, the receiving unit 610 may further be configured to: receive from the SeNB a radio resource control container associated with configuration information of the SeNB which has been changed. The device may further comprise: a determining unit (not shown) configured to check content of the radio resource control container so as to determine whether there is system information update.

According to the embodiment of the present invention, only modified radio parameters are reconfigured in the SeNB change procedure, and sending unit 620 is further configured to only send configuration information of modified radio parameters to user equipment.

FIG. 7 is a block diagram of a SeNB modification device 700 in a dual connectivity system at SeNB side according to one embodiment of the present invention. The device shown in FIG. 7 may be contained in a SeNB or any other appropriate apparatus that is available to those skilled in the art.

As shown in FIG. 7, the device 700 may comprise: a determining unit 710 configured to determine to initiate SeNB cell addition procedure; a sending unit 720 configured to send a SeNB cell addition request to a MeNB based on the determination made by determining unit 710; and a receiving unit 730 configured to receive a SeNB cell addition request acknowledgement from the MeNB.

According to the embodiment of the present invention, the determining unit 710 is further configured to determine to simultaneously initiate SeNB cell release procedure and SeNB cell addition procedure, and the sending unit 720 is further configured to simultaneously send SeNB cell addition information and SeNB cell release information to the MeNB so as to complete system information update of SeNB cells.

According to the embodiment of the present invention, the SeNB cell addition information comprises updated system information of an added SeNB cell.

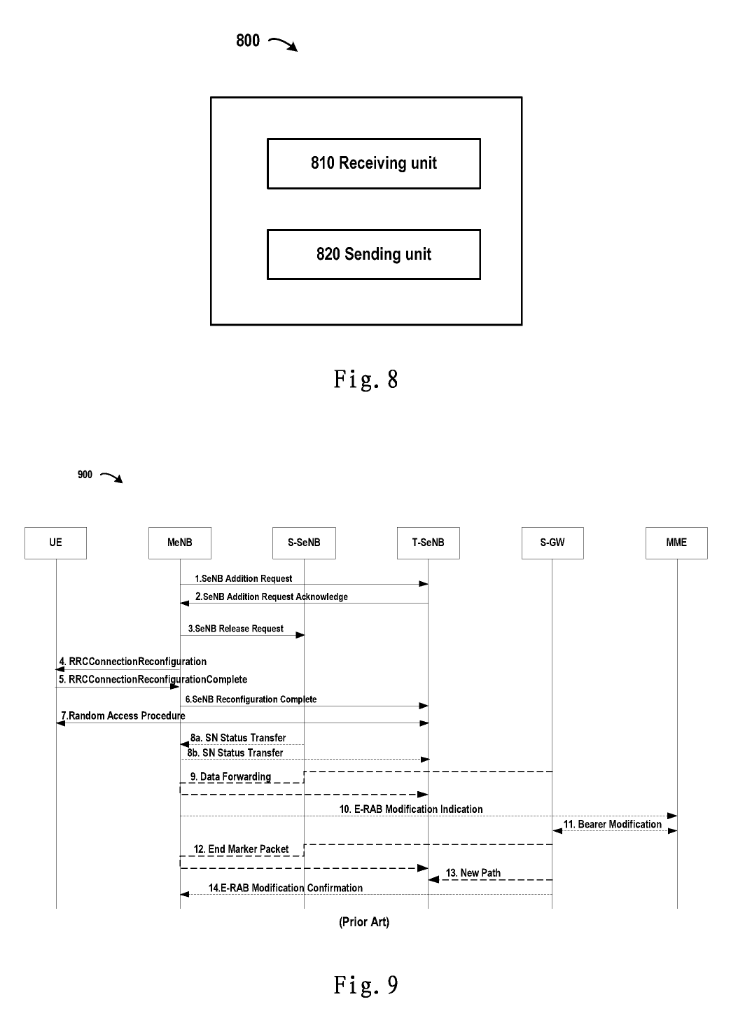

FIG. 8 is a block diagram of a SeNB modification device 800 in a dual connectivity system at MeNB side according to one embodiment of the present invention. The device shown in FIG. 8 may be contained in a MeNB or any other appropriate apparatus that is available to those skilled in the art.

As shown in FIG. 8, device 800 may comprise: a receiving unit 810 configured to receive a SeNB cell addition request from a SeNB; and a sending unit 820 configured to send a SeNB cell addition request acknowledgement to the SeNB, wherein SeNB cell addition procedure is initiated by the SeNB.

According to the embodiment of the present invention, the SeNB simultaneously initiates SeNB cell release procedure and SeNB cell addition procedure, wherein the receiving unit 810 is further configured to simultaneously receive SeNB cell addition information and SeNB cell release information from the SeNB so as to complete system information update of SeNB cells.

According to the embodiment of the present invention, the SeNB cell addition information may comprise updated system information of an added SeNB cell.

It is to be understood that the structural block diagrams shown in FIGS. 5-8 are for the purpose of illustration only, rather than limiting the present invention. In some cases, some of means/units may be added or removed according to needs.

The units included in devices 500-800 may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in device 500, 600, 700 and/or 800 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

For example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A method for performing secondary base station change in a dual connectivity system, comprising:
determining, at a secondary base station, to initiate secondary base station change procedure;
sending, at the secondary base station, a secondary base station change request to a master base station based on the determination; and
receiving a secondary base station change request acknowledgement from the master base station.

2. The method according to claim 1, wherein system information update of a secondary base station cell is performed through the secondary base station change procedure.

3. The method according to claim 2, wherein the system information update of a secondary base station cell comprises system information update of a special secondary base station cell and system information update of a secondary base station secondary cell.

4. The method according to claim 2, wherein the secondary base station change procedure is intra-secondary base station change procedure, the intra-secondary base station change procedure excluding path switch and data forwarding.

5. The method according to claim 4, further comprising: sending, by the secondary base station, to the master base station an indication that indicates the secondary base station has performed the intra-secondary base station change procedure.

6. The method according to claim 4, further comprising: sending, by the secondary base station, to the master base station a radio resource control container associated with configuration information of the secondary base station which has been changed.

7. The method according to claim 4, wherein the master base station determines whether there is system information update, by checking content of a radio resource control container received from the secondary base station.

8. The method according to claim 1, wherein only modified radio parameters are reconfigured in the secondary base station change procedure.

9. A method for performing secondary base station change in a dual connectivity system, comprising:
receiving, at a master base station, a secondary base station change request from a secondary base station; and
sending a secondary base station change request acknowledgement from the master base station to the secondary base station,
wherein secondary base station change procedure is initiated by the secondary base station.

10.-14. (canceled)

15. A secondary base station modification method in a dual connectivity system, comprising:
determining, at a secondary base station, to initiate secondary base station cell addition procedure;
sending, at the secondary base station, a secondary base station cell addition request to a master base station based on the determination; and
receiving a secondary base station cell addition request acknowledgement from the master base station,
wherein the secondary base station cell addition procedure is initiated by the secondary base station.

16.-17. (canceled)

18. A secondary base station modification method in a dual connectivity system, comprising:
receiving, at a master base station, a secondary base station cell addition request from a secondary base station; and
sending a secondary base station cell addition request acknowledgement to the secondary base station from the master base station,
wherein secondary base station cell addition procedure is initiated by the secondary base station.

19.-20. (canceled)

21. A device for performing secondary base station change in a dual connectivity system, comprising:
a determining unit configured to determine, at a secondary base station, to initiate secondary base station change procedure;
a sending unit configured to send a secondary base station change request to a master base station based on the determination made by the determining unit; and
a receiving unit configured to receive a secondary base station change request acknowledgement from the master base station.

22.-28. (canceled)

29. A device for performing secondary base station change in a dual connectivity system, comprising:
a receiving unit configured to receive a secondary base station change request from a secondary base station; and
a sending unit configured to send a secondary base station change request acknowledgement to the secondary base station,
wherein secondary base station change procedure is initiated by the secondary base station.

30.-34. (canceled)

35. A secondary base station modification device in a dual connectivity system, comprising:
a determining unit configured to determine to initiate secondary base station cell addition procedure;
a sending unit configured to send a secondary base station cell addition request to a master base station based on the determination made by the determining unit; and
a receiving unit configured to receive a secondary base station cell addition request acknowledgement from the master base station.

36.-37. (canceled)

38. A secondary base station modification device in a dual connectivity system, comprising:
a receiving unit configured to receive a secondary base station cell addition request from a secondary base station; and
a sending unit configured to send a secondary base station cell addition request acknowledgement to the secondary base station,
wherein secondary base station cell addition procedure is initiated by the secondary base station.

39.-40. (canceled)
